(19) United States
(12) Patent Application Publication
(10) Pub. No.: US 2006/0032809 A1
(43) Pub. Date: Feb. 16, 2006

(54) Dewatering bag

(76) Inventors: Mark D. Shaw, Ponte Vedra Beach, FL (US); J. Tad Heyman, Atlantic Beach, FL (US); Laurence M. Bierce, Steinhetchee, FL (US)

Correspondence Address: ROGERS TOWERS, P.A., 1301 RIVERPLACE BOULEVARD, SUITE 1500, JACKSONVILLE, FL, 32207, US

(21) Appl. No.: 11/200,844

(22) Filed: Aug. 10, 2005

Related U.S. Application Data
(60) Provisional application No. 60/600,565, filed on Aug. 11, 2004.

(51) Int. Cl. B01D 29/13

(52) U.S. Cl. 210/452; 210/483

(57) ABSTRACT

A water permeable dewatering bag for removing suspended solids from water, the bag having an open end that is sealed during the filtering operation but may be opened to remove collected solids after the filtering operation for reuse of the bag. The open is temporarily sealed using a clamping assembly such that the size of the bag may be adjusted as desired.

This application claims the benefit of U.S. Provisional Patent Application Ser. No. 60/600565, filed on Aug. 11, 2004.

### BACKGROUND OF THE INVENTION

This invention relates generally to devices known as dewatering bags, gravity bag filters or sediment filter bags, all of which are devices used to remove gravel, dirt, sediment, sand and other suspended solids from water prior to the water being discharged into the environment.

It is often necessary to remove accumulated water, such as groundwater, water from cofferdams, diverted water or water used in construction activities from construction sites or the like. This is usually accomplished by pumping, conveying and discharging the accumulated water into a drainage system or a stormwater system, or by removing the water in transport vehicles, or by piping the water to a chosen location such as a retention pond. In order to prevent the transfer of any suspended solid pollutants contained in the accumulated water, the water should be filtered prior to discharge to entrap the suspended solids, which may then be properly disposed of separately from the now filtered water.

Devices to accomplish this task comprise bags or envelopes formed of a filter material, such as a non-woven geotextile fabric, with mesh, aperture or interstitial spacing of a size capable of preventing passage of the suspended solids while allowing water to flow through the material. The bags typically have a tubular inlet opening adapted to be connected to the pump discharge hose such that all flow from the hose is directed into the interior of the bag. The bag is generally square or rectangular with a relatively large surface area in comparison to the inlet opening, such that water can spread through the bag and the flow rate from the pump discharge hose is not impeded. The filtered water passes though the bag walls and the suspended solids having a size greater than the filter apertures remain trapped within the bag. Once the build-up of trapped solids excessively interferes with the water flow rate, i.e., the filter becomes clogged, the bag is detached from the pump discharge hose and disposed of.

A problem with known dewatering bags is that they are produced in multiple sizes to account for differing applications. Typical sizes include bags of 3 feet by 3 feet, 3 feet by 5 feet, 5 feet by 7 feet, 6 feet by 6 feet, 10 feet by 15 feet, 15 feet by 15 feet, 15 feet by 20 feet, and 15 feet by 25 feet. Thus, the user must correctly ascertain the proper dewatering bag sizes that may be needed at a particular site, or must maintain a ready supply of all available sizes. Because maintaining a full supply of sizes is costly, most often the user will have only one or several sizes on hand. This often results in the use of a dewatering bag that is either too big for a particular application, when the use of a less costly smaller size would have been sufficient, or that is too small, such that the bag clogs prior to full pump out of the accumulated water, meaning that multiple bags must be used. Another problem with known dewatering bags is that they are designed for single use. Once the filtering capacity of a bag is reached, the bag is discarded. This produces excessive landfill waste and increased expense to the users, especially in circumstances where the captured sediment is not environmentally harmful.

In order to address this problem, it is an object of this invention to provide a dewatering bag that is size adjustable, whereby the filtering surface area can be increased or decreased as required to achieve the desired filter flow rate. It is a further object to provide a dewatering bag that is releasably sealed, such that trapped solids may be removed from the interior of the bag for proper disposal, thereby allowing the bag to be reused after it has been cleaned.

### SUMMARY OF THE INVENTION

The invention comprises in general a dewatering bag, also know as a gravity bag filter or sediment filter bag, used to filter large quantities of water to entrap suspended solids such as gravel, dirt, sand and other particulate debris, such that the filtered water released through the walls of the bag is environmentally safe. The invention comprises a bag or envelope, typically square or rectangular, with an inlet neck of smaller dimension being provided for temporary attachment of the device to the discharge hose of a water pump, such that water from the pump is directed into the interior of the bag. Water exits the bag through the wall material, such that any suspended particulate matter of a size greater than the size of the mesh, apertures or interstitial spacing of the wall material is trapped within the bag.

The bag further comprises size adjustment means whereby the usable filter surface area of the bag may be altered. In the preferred embodiment, the size adjustment means comprises a removable clamping assembly that allows one end or side of the bag to be folded or rolled and then secured in the folded or rolled position such that water is essentially precluded from passing through the folded or rolled portion of the bag.

The dewatering bag is most preferably provided with an open end or side that is not permanently sealed, but instead is provided with removable, releasable or temporary closure means. The closure means most preferably also serves as the size adjustment means. Upon completion of the filtering operation, the closure means is removed or released such that the bag may be opened to allow removal of the entrapped solids. Upon cleaning and resealing of the bag, the bag may then be reused.

The size adjustment means and the closure means may comprise a pair of interconnecting rod members that are joined to enclose the folded or rolled portion of the bag. Segmented anchoring members may be attached to the open end or side of the bag that cooperate with the rod members to ensure that the bag remains folded or rolled during use.

### BRIEF DESCRIPTION OF THE DRAWINGS

FIG. 1 is a top view of the dewatering bag.

FIG. 2 is a view of the dewatering bag of FIG. 1 shown prior to the sheet material being folded and joined.

FIG. 3 is an exploded view of the rod members forming the clamping assembly.

FIG. 4 is a side view of the clamping assembly showing the rod members in the assembled configuration.

FIG. 5 is a view of the dewatering bag in use, showing connection to a pump discharge hose and with a portion of the bag rolled onto the clamping assembly.

### DETAILED DESCRIPTION OF THE INVENTION

With reference to the drawings, the invention will now be described in detail with regard for the best mode and preferred embodiments. The invention generally comprises a dewatering bag, gravity bag filter or sediment filter bag 10 composed of a water permeable filter material capable of precluding suspended solids greater than a certain size from passing through the material. Suitable filtering material in sheet-form includes for example non-woven, synthetic, geotextile material such as sold under the brand names AMOCO PROPEX, MIRAFI, and TERRATEX. Such materials are durable, resistant to tear or puncture, and resistant to environmental and UV degradation. Suitable water flow rates for example may range between 70 to 110 gpm/ft² and suitable Apparent Opening Sizes for the mesh, apertures or interstitial openings in the material may range for example from U.S. Sieve No. 80 to 100, however, the invention is not to be limited to these ranges.

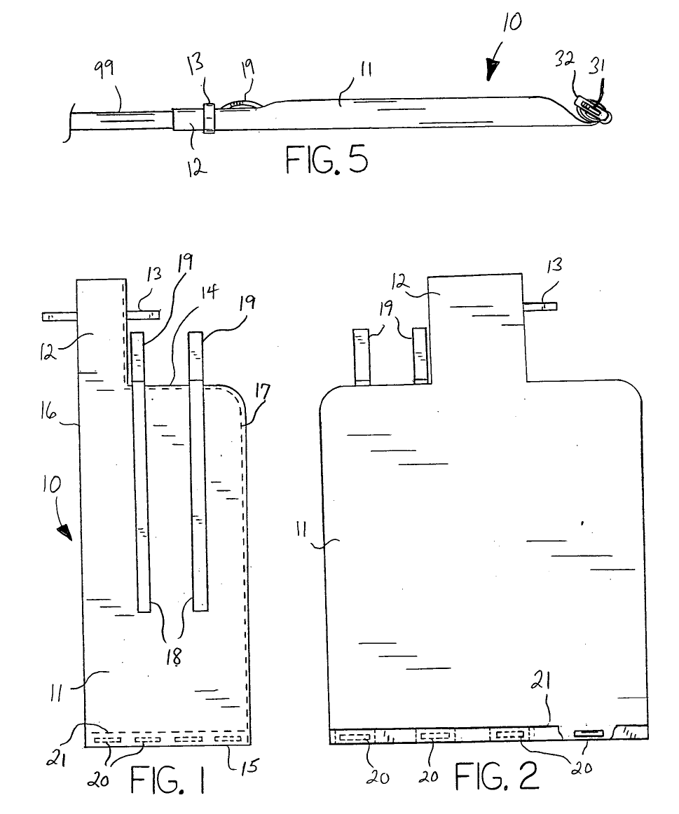

The dewatering bag 10 as shown in FIGS. 1, 2 and 5 comprises a main body 11 formed by a permanently sealed or joined end 14, a pair of opposing sealed or joined sides 16, and an unsealed or open end 15. The sealed end 14 and sealed sides 16 may be formed by stitching 17 or other equivalent means such as adhesive bonding, melt bonding, mechanical fastening or the like, in a manner whereby the end 14 and sides 16 will remain connected during use under pressure. One of the sides 16 may be created by folding the sheet material forming the main body 11 prior to stitching, as illustrated in FIG. 2. Extending from the sealed end 14 is an open, generally tubular, inlet neck 12 to receive the end of a discharge hose or pipe 99, such as coming from a pump, which is typically from about 2 to 4 inches in diameter. Neck connection means, shown herein to comprise a strap member 13 having hook-and-pile fastening elements, are provided to cinch the inlet neck 12 securely around the pump discharge hose 99 such that no water may escape from the connection. In this manner all water discharged from the pump passes through the neck inlet 12 and into the interior of the main body 11. The main body 11 may be provided with reinforcement stitching or straps 18 as well as with lifting strap members 19 to assist in moving the bag 10.

The main body 11 is preferably provided with a releasably sealable open end 15, preferably disposed opposite to the inlet neck 12, which may be closed and opened as desired utilizing sealing or closure means. Alternatively, it is to be understood that one of the sides 16 may be provided as an open side with end 15 permanently sealed, or both side 16 and end 15 may both be open and resealable, or portions of end 15 and side 16 may be open and resealable. The open end 15 is preferably provided with anchor members 20 in order to increase the rigidity of the open end 15 and to provide members to interact with the closure means to better seal the device during use. As shown, the anchor members 20 may comprise relatively short segments of PVC pipe, cylinders or similar material that are disposed within an elongated pocket flap 21. The anchor members 20 are alternately positioned such that when the sheet material is folded, the anchor members 20 will be disposed in a generally linear alignment along the open end 15, with one set of anchor members 20 being positioned in the top side of open end 15 and the other set of anchor members being positioned in the bottom side of open end 15.

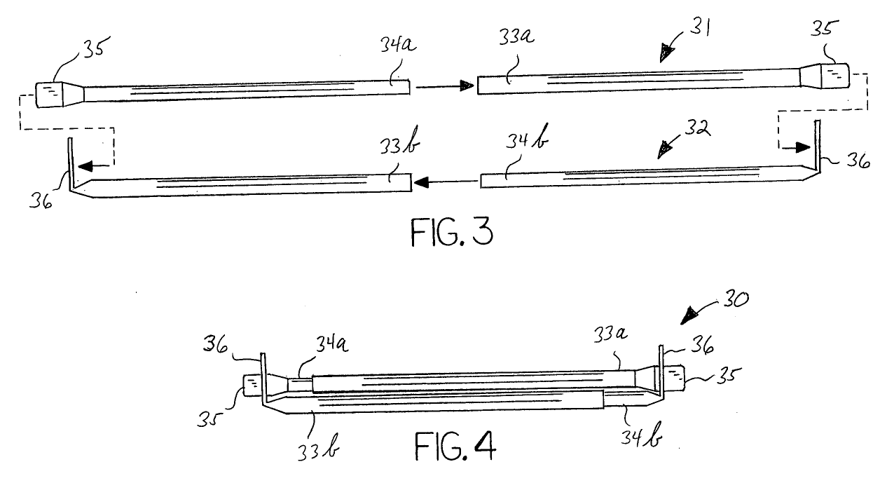

The dewatering bag 10 is preferably provided with size adjusting means as well as releasable closure means, which preferably comprise the same structural elements, whereby the surface area and overall size or dimensions of the main body 11 can be reduced or adjusted to accommodate varying water flow rates or sediment concentration. As shown, the size adjusting means and releasable closure means comprise a clamping assembly 30 that cooperates with the anchor members 20 such that the open end 15 is securely sealed when desired. The clamping assembly 30, as shown in FIGS. 3 and 4, may comprise a first elongated member 31 and a second elongated member 32, which may be formed as sleeve members 33a and 33b and insertion members 34a and 34b in order to allow the length of the clamping assembly 30 to be adjusted as desired to fit dewatering bags 10 of differing width. The first and second elongated members 31 and 32 may be formed of aluminum tubes or similar material. As shown, the first elongated member 31 is provided with tab flanges 35 on each end and the second elongated member 32 is provided with slotted flanges 36 on each end, the slots being sized to receive the tab flanges 35 therethrough.

To utilize the dewatering bag 10, the bag 10 is laid onto a relatively flat surface. The first elongated member 31 is placed abutting the pocket flap 21 retaining the anchor members 20 on the open end 15 of the bag 10. The open end 15 is then rolled or folded with first elongated member 31 acting as a spindle or shaft. One or both sides 16 may also be folded inward to further reduce the surface area of the main body 11. When the desired dimensions for the bag 10 are reached, the second elongated member 32 is connected to the first elongated member 31 by placing the slotted flanges 36 onto the tab flanges 35 to create in combination the clamping assembly 30. In this manner the open end 15 is sealed and the main body 11 is precluded from unrolling or unfolding under the pressure of the incoming water. The inlet neck 12 is connected to the pump discharge hose 99 and secured using strap 13. Water is then introduced into the dewatering bag 10. After the suspended particulates have been trapped and the water has been filtered and released through the walls of main body 11, the suspended solids trapped within the bag 10 may be accessed for removal by disassembling the clamping assembly 30, unrolling or unfolding the main body 11 and opening the open end 15. Upon removal of the solids and sufficient cleaning of the main body 11, the dewatering bag 10 may be reused by resealing the open end 15 as described above.

It is understood that equivalents and substitutions to certain elements set forth above may be obvious to those skilled in the art, and therefore the true scope and definition of the invention is to be as set forth in the following claims.

We claim:

1. A dewatering bag for removing suspended particulates or solids from water, said dewatering bag comprising:
a water permeable main body having a releasably sealable open end or side;
releasable closure means to temporarily close said open end or side;
whereby suspended particulates or solids in water directed into and through said main body are entrapped within said main body;
and further whereby said entrapped particles or solids may be removed from said main body by releasing said closure means and opening said open end or side.

2. The dewatering bag of claim 1, further comprising a neck inlet connected to said main body.

3. The dewatering bag of claim 2, further comprising neck connection means joined to said neck inlet.

4. The dewatering bag of claim 1, further comprising lifting straps connected to said main body.

5. The dewatering bag of claim 1, further comprising size adjusting means whereby the surface area of said main body may be reduced.

6. The dewatering bag of claim 5, wherein said size adjusting means is said releasable closure means.

7. The dewatering bag of claim 6, wherein said size adjusting means and said releasable closure means comprises a clamping assembly.

8. The dewatering bag of claim 7, wherein said clamping assembly comprises in combination a first elongated member and a second elongated member, whereby said open end or side of said main body is retained between said first and second elongated members.

9. The dewatering bag of claim 8, further comprising anchor members disposed in said open end or side, whereby said anchor members increase the rigidity of said open end or side and interact with said releasable closure means to better seal said main body.

10. The dewatering bag of claim 8, wherein said first elongated member comprises a pair of tab flanges and said second elongated member comprises a pair of slotted flanges to receive said tab flanges.

11. The dewatering bag of claim 8, wherein said first and second elongated members each comprise telescoping members such that the length of said first and second elongated members are adjustable.

12. A dewatering bag for removing suspended particulates or solids from water, said dewatering bag comprising:
a water permeable main body having an open end or side;
a neck inlet connected to said main body such that water is directed into said main body;
releasable closure means to temporarily close said open end or side;
size adjusting means to reduce the surface area of said main body;
whereby suspended particulates or solids in water directed into and through said main body are entrapped within said main body;
and further whereby said entrapped particles or solids may be removed from said main body by releasing said closure means and opening said open end or side.

13. The dewatering bag of claim 12, wherein said releasable closure means and said size adjusting means comprise the same elements.

14. The dewatering bag of claim 13, wherein said size adjusting means and said releasable closure means comprises a clamping assembly.

15. The dewatering bag of claim 14, wherein said clamping assembly comprises in combination a first elongated member and a second elongated member, whereby said open end or side of said main body is retained between said first and second elongated members.

16. The dewatering bag of claim 15, further comprising anchor members disposed in said open end or side, whereby said anchor members increase the rigidity of said open end or side and interact with said releasable closure means to better seal said main body.

17. The dewatering bag of claim 15, wherein said first elongated member comprises a pair of tab flanges and said second elongated member comprises a pair of slotted flanges to receive said tab flanges.

18. The dewatering bag of claim 15, wherein said first and second elongated members each comprise telescoping members such that the length of said first and second elongated members are adjustable.

19. The dewatering bag of claim 12, further comprising neck connection means joined to said neck inlet.

20. The dewatering bag of claim 12, further comprising lifting straps connected to said main body.
